(19) United States
(12) Patent Application Publication
(10) Pub. No.: US 2026/0171948 A1
(43) Pub. Date: Jun. 18, 2026

(54) POWER CONVERSION DEVICE

(71) Applicant: TOYOTA JIDOSHA KABUSHIKI KAISHA, Toyota-shi Aichi-ken (JP)

(72) Inventors: Kazuma FUJIWARA, Toyota-shi Aichi-ken (JP); Hiroshi MORITA, Toyota-shi Aichi-ken (JP); Hiroto KUSAKA, Toyota-shi Aichi-ken (JP)

(73) Assignee: TOYOTA JIDOSHA KABUSHIKI KAISHA, Toyota-shi Aichi-ken (JP)

(21) Appl. No.: 19/414,533

(22) Filed: Dec. 10, 2025

(30) Foreign Application Priority Data
Dec. 13, 2024 (JP) 2024-218927

(51) Int. Cl. H02P 27/06; H02P 25/18; H02P 29/50

(52) U.S. Cl. CPC H02P 27/06; H02P 25/184; H02P 29/50

(57) ABSTRACT

A power conversion device comprises a first inverter connected to one end of a three-phase winding of an open winding motor and a second inverter connected to the other end of the three-phase winding. The power conversion device further comprises first three-phase conductors connecting one end of each phase of the three-phase winding to each phase of the first inverter, and second three-phase conductors connecting the other end of each phase of the three-phase winding to each phase of the second inverter, wherein each phase of the first conductor and each phase of the second conductor are arranged such that the conductors of the same phase are parallel to each other and the electric currents flow in opposite directions.

### CROSS-REFERENCE TO RELATED APPLICATIONS

The present disclosure claims priority to Japanese Patent Application No. 2024-218927 filed Dec. 13, 2024, which is incorporated herein by reference in its entirety including specification, drawings and claims.

### TECHNICAL FIELD

The present disclosure relates to a power conversion device, and more particularly, to a power conversion device including a first inverter connected to one end of a three-phase winding of an open winding motor and a second inverter connected to the other end of the three-phase winding.

### BACKGROUND

Conventionally, as this type of power conversion device, there has been proposed one in which a U-phase bus bar, a V-phase bus bar, and a W-phase bus bar of a first inverter, and a U-phase bus bar, a V-phase bus bar, and a W-phase bus bar of a second inverter are arranged in a straight line in this order (see, for example, Patent Document 1). The three-phase coils of a first rotating electric machine are connected to the U-phase, V-phase, and W-phase bus bars of the first inverter, and the three-phase coils of a second rotating electric machine are connected to the U-phase, V-phase, and W-phase bus bars of the second inverter. Sensors for detecting electric currents flowing through the respective bus bars are attached to the U-phase, V-phase, and W-phase bus bars of the first inverter and the second inverter. Further, between the W-phase bus bar of the first inverter and the U-phase bus bar of the second inverter, a converter bus bar is disposed.

### CITATION LIST

### Patent Document

[Patent Document 1] Japanese Patent Application Laid Open No. 2021-164244

### SUMMARY

However, in the above-described power conversion device, in order to reduce interference caused by magnetic flux in the bus bars of each phase, it is necessary to increase the distance between the bus bars of each phase, which results in an increase in the size of the device. In addition, when a sensor that detects magnetic flux generated by the current flowing through a bus bar is used as the sensor for detecting the current flowing through each bus bar, it is also necessary to correct sensor values due to the influence of magnetic flux from other phases.

The principal object of the present disclosure is to reduce the influence of magnetic flux in the bus bars of each phase.

In order to achieve the above object, the power conversion device of the present disclosure employs the following measures.

The power conversion device of the present disclosure includes: a first inverter connected to one end of a three-phase winding of an open winding motor, a second inverter connected to the other end of the three-phase winding, first three-phase conductors connecting one end of each phase of the three-phase winding to each phase of the first inverter; and second three-phase conductors connecting the other end of each phase of the three-phase winding to each phase of the second inverter, wherein each phase of the first conductor and each phase of the second conductor are arranged such that conductors of the same phase are parallel to each other and electric currents flow in opposite directions.

In the power conversion device of the present disclosure, each phase of the first conductor and each phase of the second conductor are arranged such that conductors of the same phase are parallel to each other and electric currents flow in opposite directions. That is, the first conductor of the U-phase of the first inverter and the second conductor of the U-phase of the second inverter are arranged to be close to and parallel to each other and to carry currents in opposite directions. Likewise, the first conductor of the V-phase of the first inverter and the second conductor of the V-phase of the second inverter are arranged to be close to and parallel to each other and to carry currents in opposite directions, and the first conductor of the W-phase of the first inverter and the second conductor of the W-phase of the second inverter are arranged to be close to and parallel to each other and to carry currents in opposite directions. Since conductors of the same phase are arranged to be close to and parallel to each other and to carry currents in opposite directions, the magnetic flux generated in each phase of the first conductor is canceled by the magnetic flux generated in the conductor of the same phase of the second conductor (i.e., the magnetic flux generated in the first conductor of the U-phase of the first inverter is canceled by the magnetic flux generated in the second conductor of the U-phase of the second inverter, and similarly for the V-phase and the W-phase). Accordingly, the influence of magnetic flux in the bus bars of each phase can be reduced.

In the power conversion device of the present disclosure, it is also possible to provide three-phase current sensors disposed at positions equidistant from the conductors of the same phase between each phase of the first conductor and each phase of the second conductor. That is, a current sensor for the U-phase is disposed at a position where the distance from the first conductor of the U-phase of the first inverter and the distance from the second conductor of the U-phase of the second inverter are equal. Similarly, a current sensor for the V-phase is disposed at a position where the distance from the first conductor of the V-phase of the first inverter and the distance from the second conductor of the V-phase of the second inverter are equal, and a current sensor for the W-phase is disposed at a position where the distance from the first conductor of the W-phase of the first inverter and the distance from the second conductor of the W-phase of the second inverter are equal. By disposing the current sensors at positions equidistant from the same-phase conductors carrying currents in opposite directions, the current sensors are placed at positions where magnetic fluxes generated by the same-phase conductors reinforce each other, thereby improving the detection accuracy of the current sensors.

### BRIEF DESCRIPTION OF DRAWINGS

FIG. 1 is a configuration diagram schematically showing the electrical configuration of a drive device 20 including a power conversion device 30 according to one embodiment of the disclosure;

FIG. 2 is a schematic structural diagram schematically showing a structure of the drive device 20 including the power conversion device 30 of the embodiment;

FIG. 3 is an explanatory cross-sectional view schematically showing the vicinity of a connection portion connecting the power conversion device 30 of the embodiment to an open winding motor 70;

FIG. 4 is an explanatory cross-sectional view schematically showing the vicinity of a connection portion of the power conversion device 30 of the embodiment with a positive power line 24p and a negative power line 24n;

FIG. 5 is an explanatory diagram schematically showing the magnetic flux generated by bus bars 46U, 46V, and 46W of a first inverter 40 and bus bars 56U, 56V, and 56W of a second inverter 50;

FIG. 6 is an explanatory diagram schematically showing the first inverter 40 and the second inverter 50 when configured with three 4-in-1 modules;

FIG. 7 is an explanatory cross-sectional view schematically showing the vicinity of the connection portion of the power conversion device 30 with the positive power line 24p and the negative power line 24n when the first inverter 40 and the second inverter 50 are configured with three 4-in-1 modules, and

FIG. 8 is an explanatory diagram schematically showing the first inverter 40 and the second inverter 50 when configured with one 12-in-1 module.

FIG. 9 is an explanatory cross-sectional view schematically showing the vicinity of the connection portion of the power conversion device 30 with the positive power line 24p and the negative power line 24n when the first inverter 40 and the second inverter 50 are configured with one 12-in-1 module;

FIG. 10 is an explanatory cross-sectional view schematically showing the vicinity of the connection portion of the power conversion device 30 with the positive power line 24p and the negative power line 24n when the first inverter 40 and the second inverter 50 are configured with two 12-in-1 modules;

FIG. 11 is an explanatory diagram schematically showing a modified example of the power conversion device 30 in which the bus bars 46U, 46V, and 46W of the first inverter 40 and bus bars 56U, 56V, and 56W of the second inverter 50 are covered with insulating coating portions 47U, 47V, and 47W;

FIG. 12 is an explanatory diagram schematically showing the modified example of the power conversion device 30 in which partition walls 66U, 66V, and 66W formed of an insulating material are installed between the same-phase bus bars of the bus bars 46U, 46V, and 46W of the first inverter 40 and the bus bars 56U, 56V, and 56W of the second inverter 50;

FIG. 13 is an explanatory diagram schematically showing the modified example of the power conversion device 30 in which the negative connection terminals of the same phase are configured as common negative connection terminals 4454U, 4454V, and 4454W;

FIG. 14 is an explanatory cross-sectional view schematically showing the vicinity of the connection portion of the power conversion device 30 with the positive power line 24p and the negative power line 24n in the modified example using the common negative connection terminals 4454U, 4454V, and 4454W;

FIG. 15 is an explanatory diagram schematically showing the modified example of the power conversion device 30 in which the positive connection terminals of the same phase are configured as common positive connection terminals 4252U, 4252V, and 4252W, and

FIG. 16 is an explanatory cross-sectional view schematically showing the vicinity of the connection portion of the power conversion device 30 with the positive power line 24p and the negative power line 24n in the modified example using the common positive connection terminals 4252U, 4252V, and 4252W.

FIG. 17 is an explanatory diagram schematically showing the modified example of the power conversion device 30 in which the positive connection terminals of the same phase are configured as the common positive connection terminals 4252U, 4252V, and 4252W and the negative connection terminals of the same phase are configured as the common negative connection terminals 4454U, 4454V, and 4454W;

FIG. 18 is an explanatory cross-sectional view schematically showing the vicinity of the connection portion of the power conversion device 30 with the positive power line 24p and the negative power line 24n in the modified example in which the positive connection terminals of the same phase are configured as the common positive connection terminals 4252U, 4252V, and 4252W and the negative connection terminals of the same phase are configured as the common negative connection terminals 4454U, 4454V, and 4454W;

FIG. 19 is an explanatory diagram schematically showing the modified example of the power conversion device 30 in which the bus bars of the same phase are arranged such that their longitudinal cross-sectional surfaces face each other, and the bus bars of the different phases are also arranged such that their longitudinal cross-sectional surfaces face each other;

FIG. 20 is an explanatory diagram schematically showing the modified example of the power conversion device 30 in which the bus bars 46U, 46V, and 46W of the first inverter 40 and the bus bars 56U, 56V, and 56W of the second inverter 50 are arranged such that their longitudinal cross-sectional surfaces are placed on the same plane;

FIG. 21 is an explanatory diagram schematically showing the modified example of the power conversion device 30 in which current sensors 64U, 64V, and 64W are arranged at the positions offset from the centers between the same-phase bus bars while being equidistant from the same-phase bus bars;

FIG. 22 is an explanatory diagram schematically showing another modified example of the power conversion device 30 in which the current sensors 64U, 64V, and 64W are arranged at the positions offset from the centers between the same-phase bus bars while being equidistant from the same-phase bus bars;

FIG. 23 is an explanatory diagram schematically showing still another modified example of the power conversion device 30 in which the current sensors 64U, 64V, and 64W are arranged at the positions offset from the centers between the same-phase bus bars while being equidistant from the same-phase bus bars;

FIG. 24 is an explanatory diagram schematically showing the modified example of the power conversion device 30 in which recesses are formed on the facing surfaces of the same-phase bus bars of the bus bars 46U, 46V, and 46W of the first inverter 40 and the bus bars 56U, 56V, and 56W of the second inverter 50, and the current sensors 64U, 64V, and 64W are arranged so as to be fitted into the recesses, and

FIG. 25 is an explanatory diagram schematically showing the modified example of the power conversion device 30 in which the same-phase bus bars of the bus bars 46U, 46V, and 46W of the first inverter 40 and the bus bars 56U, 56V, and 56W of the second inverter 50 are covered with magnetic cores 68U, 68V, and 68W.

### DESCRIPTION OF EMBODIMENTS

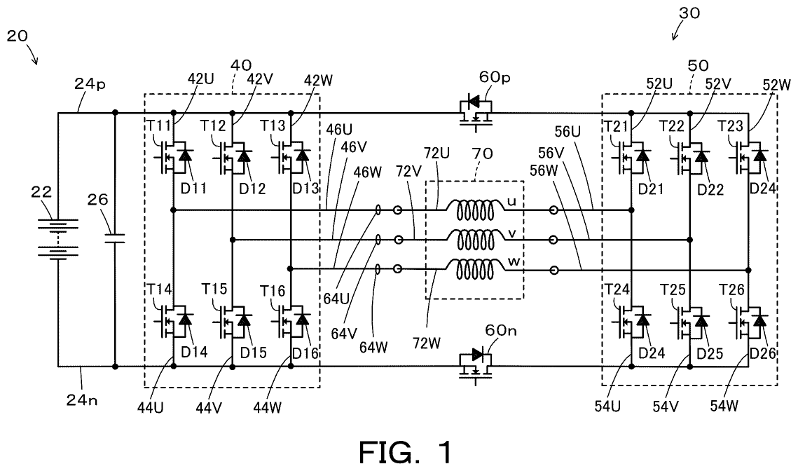

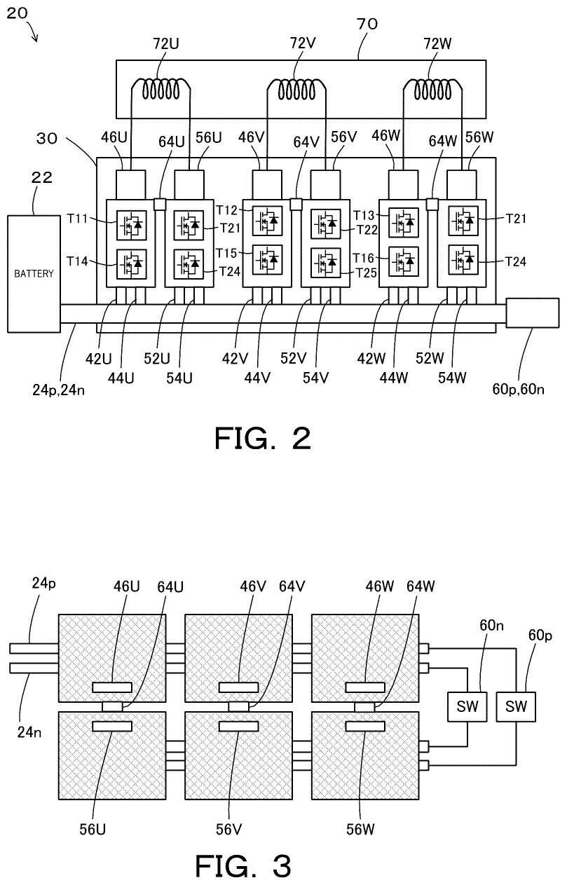

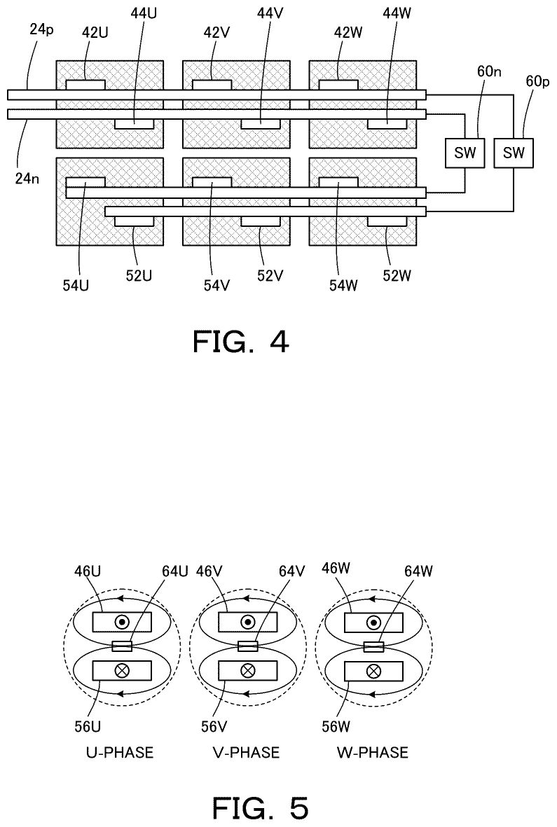

Next, an embodiment (mode for carrying out the disclosure) for implementing the present disclosure will be described. FIG. 1 is the configuration diagram schematically showing the electrical configuration of the drive device 20 including the power conversion device 30 according to one embodiment of the present disclosure. FIG. 2 is the schematic structural diagram schematically showing the structure of the drive device 20 including the power conversion device 30 of the embodiment. FIG. 3 is the explanatory cross-sectional view schematically showing the vicinity of the connection portion connecting the power conversion device 30 of the embodiment to the open winding motor 70. FIG. 4 is the explanatory cross-sectional view schematically showing the vicinity of the connection portion of the power conversion device 30 of the embodiment with the positive power line 24p and the negative power line 24n. The drive device 20 of the embodiment comprises the battery 22, the power conversion device 30, and the open winding motor 70.

The battery 22 is configured, for example, as a lithium-ion secondary battery or a nickel-metal hydride secondary battery, and the positive and negative terminals thereof are connected to the positive power line 24p and the negative power line 24n, respectively. A smoothing capacitor 26 is attached to the positive power line 24p and the negative power line 24n.

The power conversion device 30 includes the first inverter 40, the second inverter 50, and connection switches 60p and 60n.

The first inverter 40 is connected to the positive power line 24p and the negative power line 24n to which the battery 22 is connected, and has the six transistors T11 to T16 serving as switching elements, and the six diodes D11 to D16 connected in parallel to the respective six transistors T11 to T16. The transistors T11 to T16 are configured, for example, by a SiC-MOSFET (Silicon Carbide-Metal Oxide Semiconductor Field Effect Transistor). Among the transistors T11 to T16, paired transistors in twos (the transistors T11 and T14, the transistors T12 and T15, and the transistors T13 and T16) are arranged to serve as a source side and a sink side with respect to the positive power line 24p and the negative power line 24n, and, as shown in FIGS. 1 and 4, are connected to the positive power line 24 p through positive connection terminals 42U, 42V, and 42W, and are connected to negative power line 24n through the negative connection terminals 44U, 44V, and 44W. Further, each of connection points of the paired transistors T11 to T16 is connected, as shown in FIGS. 1 and 2, to one end of the three-phase coils 72U, 72V, and 72W of the open winding motor 70 through bus bars 46U, 46V, and 46W formed of the conductive metal. The first inverter 40 is configured such that, for each phase, the paired two transistors and the two diodes connected in parallel thereto constitute a module (2-in-1 module), and the three modules constitute the first inverter 40.

The second inverter 50 is connected to the positive power line 24p and the negative power line 24n to which the battery 22 is connected so as to interpose the first inverter 40 with respect to the battery 22, and has the six transistors T21 to T26 serving as the switching elements, and the six diodes D21 to D26 connected in parallel to the respective six transistors T21 to T26. The transistors T21 to T26 are configured, similarly to the transistors T11 to T16 of the first inverter 40, by a SiC-MOSFET (Silicon Carbide Metal Oxide Semiconductor Field Effect Transistor). Among the transistors T21 to T26, paired transistors in twos (the transistors T21 and T24, the transistors T22 and T25, and the transistors T23 and T26) are arranged to serve as the source side and the sink side with respect to the positive power line 24p and the negative power line 24n, and, as shown in FIGS. 1 and 4, are connected to the positive power line 24p through the positive connection terminals 52U, 52V, and 52W, and are connected to the negative power line 24n through the negative connection terminals 54U, 54V, and 54W. Further, each of the connection points of the paired transistors T21 to T26 is connected, as shown in FIGS. 1 and 2, to the other end of the three-phase coils 72U, 72V, and 72W of the open winding motor 70 through the bus bars 56U, 56V, and 56W formed of the conductive metal. The second inverter 50, similarly to the first inverter 40, is configured such that, for each phase, the paired two transistors and the two diodes connected in parallel thereto constitute a module (2-in-1 module), and the three modules constitute the second inverter 50.

The connection switch 60p is attached between the first inverter 40 and the second inverter 50 of the positive power line 24p, and the connection switch 60n is attached between the first inverter 40 and the second inverter 50 of the negative power line 24n. The connection switches 60p and 60n are configured, similarly to the transistors T11 to T16 of the first inverter 40 and the transistors T21 to T26 of the second inverter 50, by a SiC-MOSFET (Silicon Carbide-Metal Oxide Semiconductor Field Effect Transistor).

The open winding motor 70 is the generator motor in which both ends of the three-phase coils 72U, 72V, and 72W of the u-phase, v-phase, and w-phase are configured as the connection terminals. Three connection points of the paired two transistors of the first inverter 40 are connected to one end of the three-phase coils 72U, 72V, and 72W through the bus bars 46U, 46V, and 46W, and three connection points of the paired two transistors of the second inverter 50 are connected to the other end of the three-phase coils 72U, 72V, and 72W through the bus bars 56U, 56V, and 56W.

In the power conversion device 30 of the embodiment, by turning off the connection switches 60p and 60n, and turning on the upper-arm transistors T21 to T23 of the second inverter 50 while turning off the lower-arm transistors T24 to T26, the transistors T11 to T16 of the first inverter 40 are switching-controlled such that the open winding motor 70 can be driven in a star connection. That is, by turning off the connection switches 60p and 60n, and turning on the upper-arm transistors T21 to T23 of the second inverter 50, the u-phase, v-phase, and w-phase of the open winding motor 70 are turned on, the neutral point is configured by the transistors T21 to T23, and the open winding motor 70 is driven as a star-connected motor by the first inverter 40. On the other hand, by turning on the connection switches 60p and 60n, switching-controlling the transistors T11 to T16 of the first inverter 40, and switching-controlling the transistors T21 to T26 of the second inverter 50, the open winding motor 70 can be driven in a delta connection.

The bus bars 46U, 46V, and 46W of the first inverter 40 and the bus bars 56U, 56V, and 56W of the second inverter 50, which are connected to the three-phase coils 72U, 72V, and 72W of the open winding motor 70, are formed, as shown in FIG. 3, with the rectangular cross-section, and the bus bars of the same phase (the bus bars 46U and 56U, the bus bars 46V and 56V, and the bus bars 46W and 56W) are arranged such that the longitudinal cross-sectional surfaces face each other and are aligned in parallel, and electric currents flow in opposite directions. The bus bars 46U, 46V, and 46W and the bus bars 56U, 56V, and 56W are arranged such that the distance between the same-phase bus bars (the distance between the bus bars 46U and 56U, the distance between the bus bars 46V and 56V, and the distance between the bus bars 46W and 56W) is shorter than the distance between the different-phase bus bars (the distance between the U-phase bus bar and the V-phase bus bar, the distance between the V-phase bus bar and the W-phase bus bar, and the distance between the W-phase bus bar and the U-phase bus bar). In other words, the distance between the different-phase bus bars is longer than the distance between the same-phase bus bars. This arrangement is for reducing the influence of magnetic flux generated by the current flowing through the different-phase bus bars. In addition, between the same-phase bus bars, the current sensors 64U, 64V, and 64W for detecting the current based on the intensity of the magnetic flux at the positions equidistant from the bus bars are disposed.

FIG. 5 is an explanatory diagram schematically showing the magnetic flux generated by the bus bars 46U, 46V, and 46W of the first inverter 40 and the bus bars 56U, 56V, and 56W of the second inverter 50. In the figure, a circular mark including a black dot at the center represents that the current flowing through the bus bar flows from the back surface to the front surface, and a circular mark including a cross at the center represents that the current flowing through the bus bar flows from the front surface to the back surface. Since the bus bars of the same phase (the bus bars 46U and 56U, the bus bars 46V and 56V, and the bus bars 46W and 56W) carry currents in opposite directions, the magnetic flux generated by one of the same-phase bus bars cancels the magnetic flux generated by the other, and the magnetic flux generated by the same-phase bus bars as a whole becomes small. Therefore, the influence of the magnetic flux generated by the same-phase bus bars on the other phases becomes small. On the other hand, between the same-phase bus bars, the magnetic flux generated by the respective bus bars reinforces each other, such that the current sensors 64U, 64V, and 64W disposed at the centers between the same-phase bus bars can accurately detect the current flowing through the same-phase bus bars. Further, as described above, since the influence of the magnetic flux generated by the same-phase bus bars on the other phases becomes small, the current sensors 64U, 64V, and 64W are less affected by the magnetic flux generated by the other phases, and the detection accuracy is improved.

In the power conversion device 30 of the embodiment described above, the bus bars 46U, 46V, and 46W of the first inverter 40 and the bus bars 56U, 56V, and 56W of the second inverter 50 are arranged such that the bus bars of the same phase are aligned in parallel with their longitudinal cross-sectional surfaces facing each other and the currents flow in opposite directions. Therefore, since the magnetic flux generated by the current flowing through each of the same-phase bus bars cancels each other on the outer peripheral side of the same-phase bus bars, the influence of the magnetic flux generated by the current flowing through each of the same-phase bus bars on the other phases can be reduced. In addition, since the distance from the different-phase bus bars is arranged to be longer than the distance between the same-phase bus bars, the influence of the magnetic flux generated by the current flowing through each of the same-phase bus bars on the other phases can be further reduced. Furthermore, the clearance between the same-phase bus bars can be reduced. As a result, miniaturization of the power conversion device 30 can be achieved.

In the power conversion device 30 of the embodiment, the bus bars of the same phase are arranged such that their longitudinal cross-sectional surfaces face each other and are aligned in parallel, and the currents flow in opposite directions, and the current sensors 64U, 64V, and 64W are disposed at the positions equidistant from the bus bars between the bus bars of the same phase. Since the magnetic flux generated by the current flowing through each of the same-phase bus bars reinforces each other between the same-phase bus bars, the current sensors 64U, 64V, and 64W disposed between the same-phase bus bars can accurately detect the current flowing through the same-phase bus bars. Moreover, since the influence of the magnetic flux generated by the same-phase bus bars on the other phases becomes small, the influence of the magnetic flux generated by the other phases on the current sensors 64U, 64V, and 64W can be reduced, and the detection accuracy can be further improved.

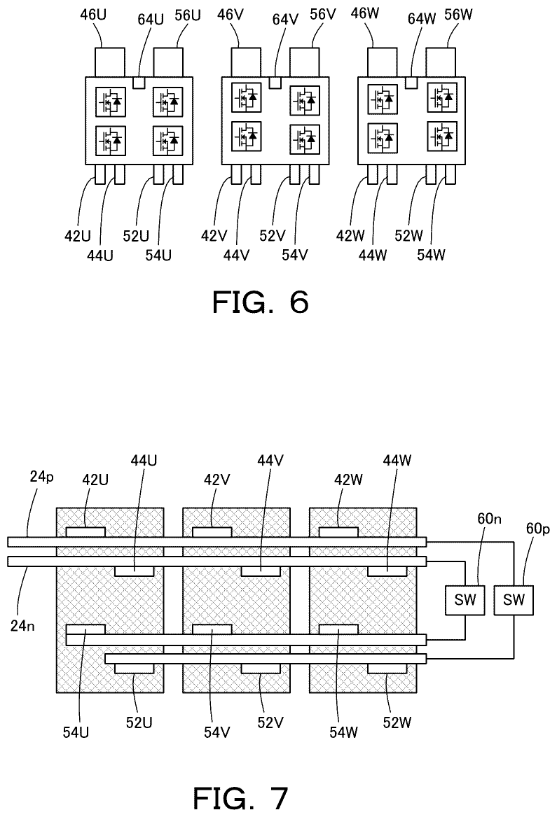

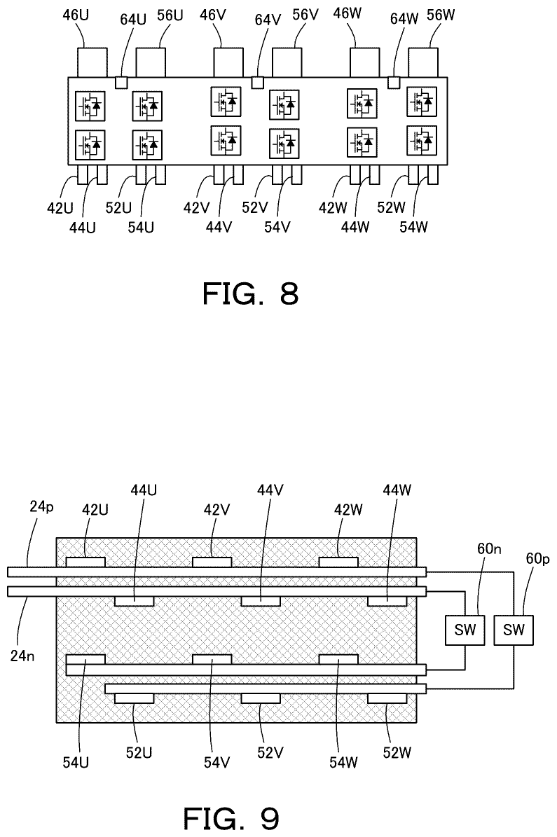

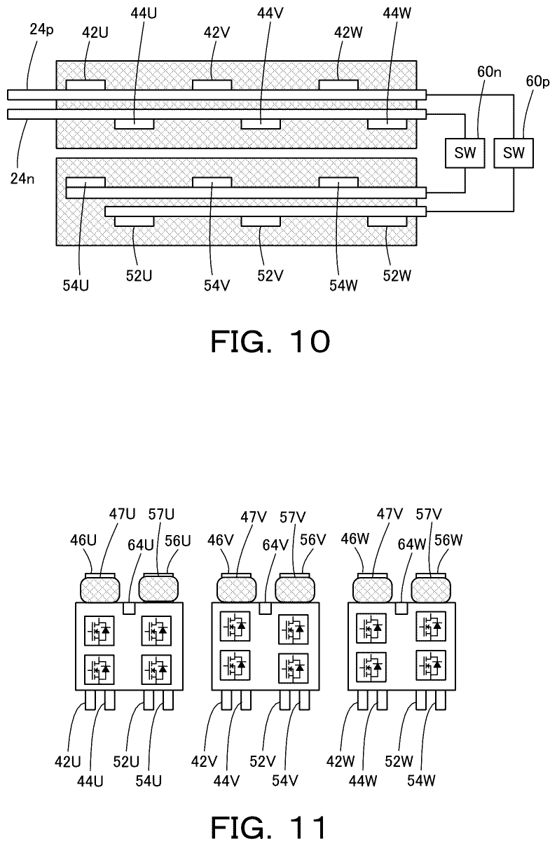

In the power conversion device 30 of the embodiment, the first inverter 40 and the second inverter 50 are configured with six 2-in-1 modules, each of which is formed by the paired two transistors of each phase and the two diodes connected in parallel thereto. However, as shown in FIGS. 6 and 7, it is also possible to configure the first inverter 40 and the second inverter 50 with three 4-in-1 modules, each of which is formed by the paired two transistors of each phase of the first inverter 40 and the two diodes connected in parallel thereto and the paired two transistors of the same phase of the second inverter 50 and the two diodes connected in parallel thereto. Further, as shown in FIGS. 8 and 9, it is also possible to configure the first inverter 40 and the second inverter 50 with one 12-in-1 module, which is formed by all of the transistors of the first inverter 40 and the diodes connected in parallel thereto and all of the transistors of the second inverter 50 and the diodes connected in parallel thereto. Furthermore, as shown in FIG. 10, it is also possible to configure the first inverter 40 and the second inverter 50 with two 6-in-1 modules, in which all of the transistors of the first inverter 40 and the diodes connected in parallel thereto constitute the one 6-in-1 module, and all of the transistors of the second inverter 50 and the diodes connected in parallel thereto constitute the other 6-in-1 module.

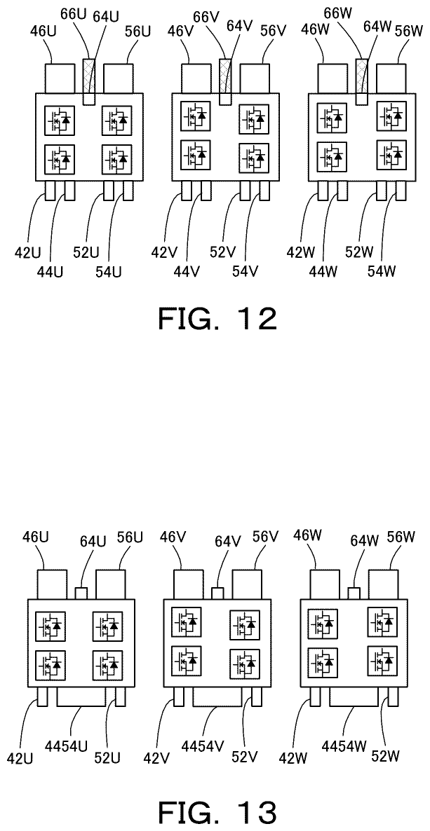

In the power conversion device 30 of the embodiment, the bus bars 46U, 46V, and 46W of the first inverter 40 and the bus bars 56U, 56V, and 56W of the second inverter 50 are configured such that the conductors are exposed directly from the modules. However, as shown in the modified example of FIG. 11, it is also possible to cover the bus bars 46U, 46V, and 46W of the first inverter 40 and the bus bars 56U, 56V, and 56W of the second inverter 50 with the insulating coating portions 47U, 47V, 47W, 57U, 57V, and 57W formed of an insulating material, except for the connection end portions connected to the three-phase coils 72U, 72V, and 72W of the open winding motor 70. In this case, short-circuiting between the terminals due to intrusion of foreign matter can be more reliably prevented. Moreover, as shown in the modified example of FIG. 12, it is also possible to install the partition walls 66U, 66V, and 66W formed of an insulating material between the same-phase bus bars of the bus bars 46U, 46V, and 46W of the first inverter 40 and the bus bars 56U, 56V, and 56W of the second inverter 50. In this case as well, short-circuiting between the terminals due to intrusion of foreign matter can be more reliably prevented.

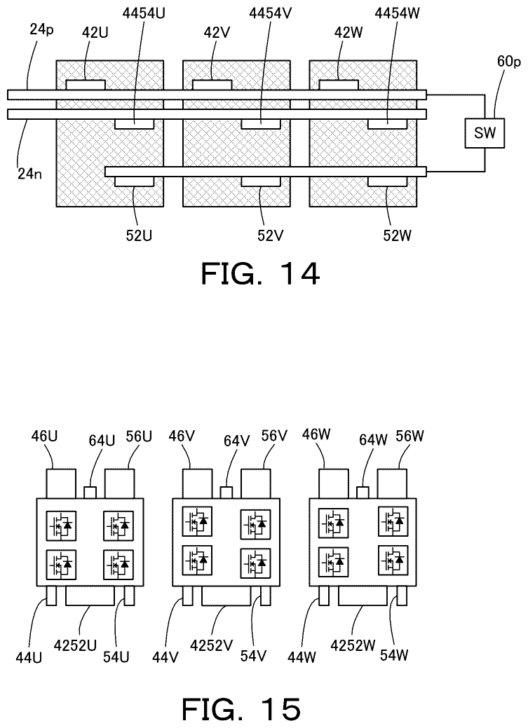

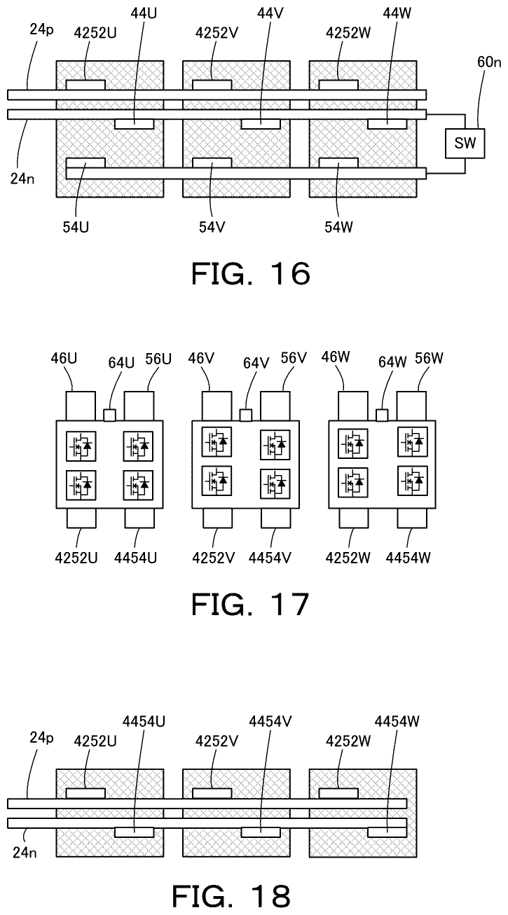

In the power conversion device 30 of the embodiment, the connection switch 60p is attached between the first inverter 40 and the second inverter 50 of the positive power line 24p, and the connection switch 60n is attached between the first inverter 40 and the second inverter 50 of the negative power line 24n. However, it is acceptable that either one or both of the connection switch 60p and the connection switch 60n are not attached. When the connection switch 60n is not attached between the first inverter 40 and the second inverter 50 of the negative power line 24n, as shown in FIGS. 13 and 14, the negative connection terminals 44U, 44V, and 44W of the first inverter 40 and the negative connection terminals 54U, 54V, and 54W of the second inverter 50 may be configured such that the negative connection terminals of the same phase constitute the common negative connection terminals 4454U, 4454V, and 4454W. Also, when the connection switch 60p is not attached between the first inverter 40 and the second inverter 50 of the positive power line 24p, as shown in FIGS. 15 and 16, the positive connection terminals 42U, 42V, and 42W of the first inverter 40 and the positive connection terminals 52U, 52V, and 52W of the second inverter 50 may be configured such that the positive connection terminals of the same phase constitute the common positive connection terminals 4252U, 4252V, and 4252W. Furthermore, when neither the connection switch 60p nor the connection switch 60n is attached between the first inverter 40 and the second inverter 50 of the positive power line 24p and the negative power line 24n, as shown in FIGS. 17 and 18, the positive connection terminals 42U, 42V, and 42W of the first inverter 40 and the positive connection terminals 52U, 52V, and 52W of the second inverter 50 may be configured such that the positive connection terminals of the same phase constitute the common positive connection terminals 4252U, 4252V, and 4252W, and the negative connection terminals 44U, 44V, and 44W of the first inverter 40 and the negative connection terminals 54U, 54V, and 54W of the second inverter 50 may be configured such that the negative connection terminals of the same phase constitute the common negative connection terminals 4454U, 4454V, and 4454W.

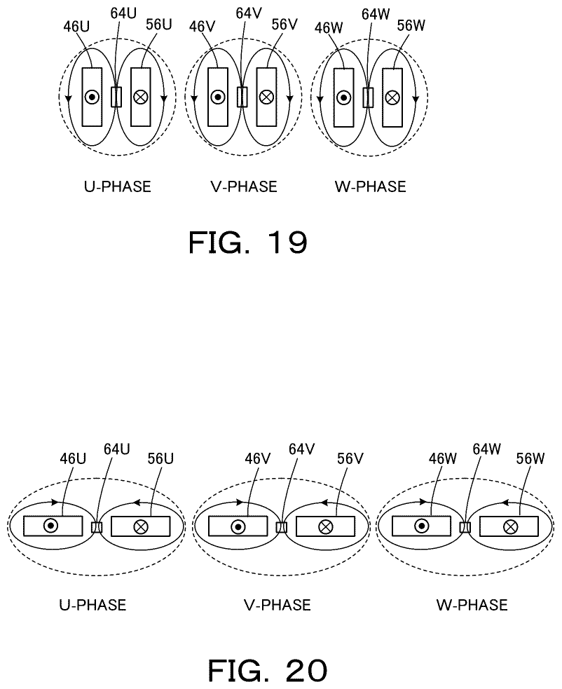

In the power conversion device 30 of the embodiment, as shown in FIG. 5, the bus bars 46U, 46V, and 46W of the first inverter 40 are arranged such that their longitudinal cross-sectional surfaces are placed on the same plane, and the bus bars 56U, 56V, and 56W of the second inverter 50 are arranged such that their longitudinal cross-sectional surfaces are placed on the same plane, and the bus bars of the same phase are arranged such that their longitudinal cross-sectional surfaces face each other. However, as shown in the modified example of FIG. 19, it is also possible that the bus bars of the same phase are arranged such that their longitudinal cross-sectional surfaces face each other, and the bus bars of the different phases are arranged such that their longitudinal cross-sectional surfaces face each other. Also, as shown in FIG. 20, it is also possible that the bus bars 46U, 46V, and 46W of the first inverter 40 are arranged such that their longitudinal cross-sectional surfaces are placed on the same plane, and the bus bars 56U, 56V, and 56W of the second inverter 50 are arranged such that their longitudinal cross-sectional surfaces are placed on the same plane, and further, all of the bus bars 46U, 46V, and 46W of the first inverter 40 and all of the bus bars 56U, 56V, and 56W of the second inverter 50 are arranged such that their longitudinal cross-sectional surfaces are placed on the same plane.

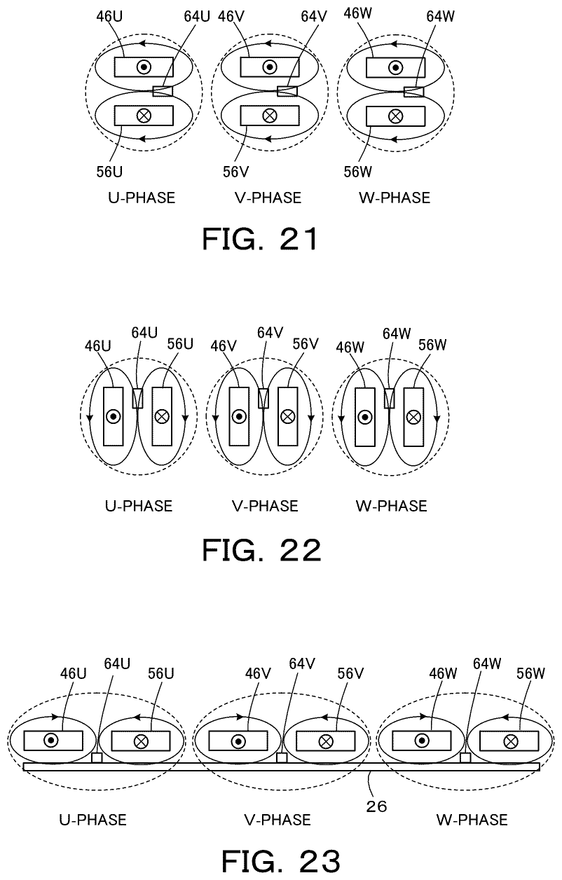

In the power conversion device 30 of the embodiment, the current sensors 64U, 64V, and 64W are arranged at the centers between the same-phase bus bars of the bus bars 46U, 46V, and 46W of the first inverter 40 and the bus bars 56U, 56V, and 56W of the second inverter 50. However, since the positions where the current sensors 64U, 64V, and 64W are arranged only need to be equidistant from the same-phase bus bars, as shown in FIGS. 21 to 23, the current sensors 64U, 64V, and 64W may be arranged at positions offset from the centers between the same-phase bus bars while being equidistant from the same-phase bus bars.

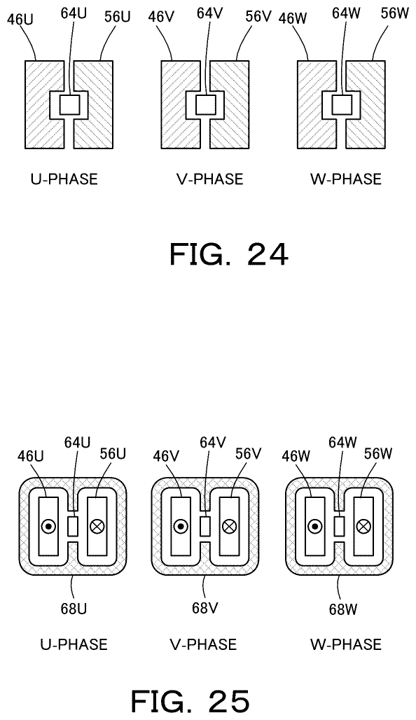

In the power conversion device 30 of the embodiment, the current sensors 64U, 64V, and 64W are arranged at the centers between the same-phase bus bars of the bus bars 46U, 46V, and 46W of the first inverter 40 and the bus bars 56U, 56V, and 56W of the second inverter 50. However, as shown in the modified example of FIG. 24, it is also possible to form the recesses on the facing surfaces of the same-phase bus bars of the bus bars 46U, 46V, and 46W of the first inverter 40 and the bus bars 56U, 56V, and 56W of the second inverter 50, and to arrange the current sensors 64U, 64V, and 64W so as to be fitted into the centers of the recesses of the same-phase bus bars. By doing so, since the intensity of the magnetic flux, which is reinforced by the currents flowing through the respective same-phase bus bars, becomes larger, the detection accuracy of the current sensors 64U, 64V, and 64W can be further improved.

In the power conversion device 30 of the embodiment, the current sensors 64U, 64V, and 64W are arranged at the centers between the same-phase bus bars of the bus bars 46U, 46V, and 46W of the first inverter 40 and the bus bars 56U, 56V, and 56W of the second inverter 50. However, it is also possible to cover the surroundings of the same-phase bus bars of the bus bars 46U, 46V, and 46W of the first inverter 40 and the bus bars 56U, 56V, and 56W of the second inverter 50 with the magnetic cores 68U, 68V, and 68W. In embodiments, the magnetic cores 68U, 68V, and 68W are formed so as to have the open ends in the vicinity of the current sensors 64U, 64V, and 64W. By doing so, since the intensity of the magnetic flux, which is reinforced by the currents flowing through the respective same-phase bus bars, becomes larger, the detection accuracy of the current sensors 64U, 64V, and 64W can be further improved.

In the power conversion device of the present disclosure, the first conductor and the second conductor are formed with a rectangular cross-section, and each phase of the first conductor and each phase of the second conductor may be arranged such that the conductors of the same phase face each other or are placed on the same plane. That is, it may be arranged such that the longitudinal cross-sectional surface of the first conductor and the longitudinal cross-sectional surface of the second conductor face each other, or it may be arranged such that the longitudinal cross-sectional surface of the first conductor and the longitudinal cross-sectional surface of the second conductor are placed on the same plane.

In the power conversion device of the present disclosure, each phase of the first conductor and each phase of the second conductor may be arranged such that the distance between the conductors of the same phase is shorter than the distance between the conductors of the different phases. By doing so, the influence of magnetic flux of the different phases can be further reduced.

In the power conversion device of the present disclosure, an insulating wall may be disposed between the conductors of the same phase of the first conductor and the second conductor. By doing so, unexpected short-circuiting can be more reliably avoided.

In the power conversion device of the present disclosure, each phase of the first conductor and each phase of the second conductor may be covered with an insulating material. By doing so, unexpected short-circuiting can be more reliably avoided.

In the power conversion device of the present disclosure, the connection terminals of each phase of the first inverter and the connection terminals of each phase of the second inverter may be configured such that at least one of the positive-side or negative-side terminals of the same phase is constituted as the common terminal. By doing so, the number of terminals can be reduced.

In the power conversion device of the present disclosure, a switch for performing connection and disconnection may be provided in at least one of the positive-side line or the negative-side line connecting the first inverter and the second inverter. By doing so, a star connection and a delta connection of the three-phase winding of the open winding motor can be switched.

In the power conversion device of each aspect of the present disclosure, the three-phase current sensors may be provided at the positions equidistant from the conductors of the same phase between each phase of the first conductor and each phase of the second conductor. That is, the current sensor for the U-phase is arranged at the position where the distance from the first conductor of the U-phase of the first inverter and the distance from the second conductor of the U-phase of the second inverter are the same, the current sensor for the V-phase is arranged at the position where the distance from the first conductor of the V-phase of the first inverter and the distance from the second conductor of the V-phase of the second inverter are the same, and the current sensor for the W-phase is arranged at the position where the distance from the first conductor of the W-phase of the first inverter and the distance from the second conductor of the W-phase of the second inverter are the same. Arranging the current sensors at the positions equidistant from the conductors of the same phase in which the directions of the currents are opposite means that the current sensors are placed at the positions where the magnetic fluxes generated by the respective conductors of the same phase reinforce each other, and therefore the detection accuracy of the current sensors can be improved.

In the power conversion device of the present disclosure provided with such three-phase current sensors, the three-phase current sensors may be disposed between the conductors of the same phase. By doing so, the magnetic fluxes generated by the respective conductors of the same phase can be further reinforced, and the detection accuracy by the current sensors can be further improved. In this case, the opposing surfaces of the conductors of the same phase of the first conductor and the second conductor are formed with recesses, and the three-phase current sensors may be arranged so as to be fitted into the recesses of the conductors of the same phase. Moreover, magnetic cores including the open ends in the vicinity of the three-phase current sensors may be disposed around each phase of the first conductor and each phase of the second conductor. By doing so, the detection accuracy by the current sensors can be further improved.

The correspondence between the main elements of the embodiment and the main elements of the disclosure described in Summary will be explained. In the embodiment, the open winding motor 70 corresponds to “the open winding motor,” the three-phase coils 72U, 72V, and 72W correspond to “the three-phase winding,” the first inverter 40 corresponds to “the first inverter,” the second inverter 50 corresponds to “the second inverter,” the bus bars 46U, 46V, and 46W of the first inverter 40 correspond to “the first three-phase conductors,” and the bus bars 56U, 56V, and 56W of the second inverter 50 correspond to “the second three-phase conductors.”

The correspondence between the major elements of the embodiment and the major elements of the disclosure described in Summary is an example of how the embodiment can be used to specifically explain the embodiment of the disclosure described in Summary. This does not limit the elements of the disclosure described in Summary. In other words, interpretation of the disclosure described in Summary should be based on the description in that section, and the embodiment is only one specific example of the disclosure described in Summary.

The present disclosure has been described above using the embodiment, but the present disclosure is not limited to such embodiment, and it is of course possible to implement the present disclosure in various forms within the scope not departing from the gist of the present disclosure.

### INDUSTRIAL APPLICABILITY

The present disclosure is applicable to the manufacturing industry of a power conversion device and the like.

1. A power conversion device comprising:
a first inverter connected to one end of a three-phase winding of an open winding motor;
a second inverter connected to the other end of the three-phase winding;
first three-phase conductors connecting one end of each phase of the three-phase winding to each phase of the first inverter; and
second three-phase conductors connecting the other end of each phase of the three-phase winding to each phase of the second inverter,
wherein each phase of the first conductor and each phase of the second conductor are arranged such that conductors of the same phase are parallel to each other and electric currents flow in opposite directions.

2. The power conversion device according to claim 1,
wherein the first conductor and the second conductor are formed with a rectangular cross-section, and
each phase of the first conductor and each phase of the second conductor are arranged such that conductors of the same phase face each other or are on the same plane.

3. The power conversion device according to claim 1,
wherein each phase of the first conductor and each phase of the second conductor are arranged such that a distance between conductors of the same phase is shorter than a distance to conductors of other phases.

4. The power conversion device according to claim 1,
wherein an insulating wall is disposed between conductors of the same phase of the first conductor and the second conductor.

5. The power conversion device according to claim 1,
wherein each phase of the first conductor and each phase of the second conductor are each covered with an insulating material.

6. The power conversion device according to claim 1,
wherein a connection terminal of each phase of the first inverter and a connection terminal of each phase of the second inverter are configured such that at least one of the same-phase positive-side terminal or negative-side terminal is constituted as a common terminal.

7. The power conversion device according to claim 1,
further comprising a switch configured to connect and disconnect at least one of a positive-side line or a negative-side line connecting the first inverter and the second inverter.

8. The power conversion device according to claim 1,
further comprising three-phase current sensors disposed at positions equidistant from the conductors of the same phase between each phase of the first conductor and each phase of the second conductor.

9. The power conversion device according to claim 8,
wherein the three-phase current sensors are disposed between the conductors of the same phase.

10. The power conversion device according to claim 9,
wherein opposing surfaces of the conductors of the same phase of the first conductor and the second conductor are formed with recesses, and
the three-phase current sensors are disposed so as to be fitted into the recesses of the conductors of the same phase.

11. The power conversion device according to claim 9,
wherein magnetic cores including open ends in a vicinity of the three-phase current sensors are disposed around each phase of the first conductor and each phase of the second conductor.

12. The power conversion device according to claim 2,
further comprising three-phase current sensors disposed at positions equidistant from conductors of the same phase between each phase of the first conductor and each phase of the second conductor.

13. The power conversion device according to claim 12,
wherein the three-phase current sensors are disposed between the conductors of the same phase.

14. The power conversion device according to claim 13,
wherein opposing surfaces of the conductors of the same phase of the first conductor and the second conductor are formed with recesses, and
the three-phase current sensors are disposed so as to be fitted into the recesses of the conductors of the same phase.

15. The power conversion device according to claim 13,
wherein magnetic cores including open ends in a vicinity of the three-phase current sensors are disposed around each phase of the first conductor and each phase of the second conductor.

16. The power conversion device according to claim 3,
further comprising three-phase current sensors disposed at positions equidistant from conductors of the same phase between each phase of the first conductor and each phase of the second conductor.

17. The power conversion device according to claim 16,
wherein the three-phase current sensors are disposed between the conductors of the same phase.

18. The power conversion device according to claim 17,
wherein opposing surfaces of the conductors of the same phase of the first conductor and the second conductor are formed with recesses, and
the three-phase current sensors are disposed so as to be fitted into the recesses of the conductors of the same phase.

19. The power conversion device according to claim 17,
wherein magnetic cores including open ends in a vicinity of the three-phase current sensors are disposed around each phase of the first conductor and each phase of the second conductor.

20. The power conversion device according to claim 6,
further comprising three-phase current sensors disposed at positions equidistant from conductors of the same phase between each phase of the first conductor and each phase of the second conductor.

21. The power conversion device according to claim 20,
wherein the three-phase current sensors are disposed between the conductors of the same phase.

22. The power conversion device according to claim 21,
wherein opposing surfaces of the conductors of the same phase of the first conductor and the second conductor are formed with recesses, and
the three-phase current sensors are disposed so as to be fitted into the recesses of the conductors of the same phase.

23. The power conversion device according to claim 21,
wherein magnetic cores including open ends in a vicinity of the three-phase current sensors are disposed around each phase of the first conductor and each phase of the second conductor.
